(19) United States
(12) Patent Application Publication
(10) Pub. No.: US 2005/0036712 A1
(43) Pub. Date: Feb. 17, 2005

(54) Image retrieving apparatus and image retrieving program

(76) Inventor: Toshiaki Wada, Tama-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 10/833,727

(22) Filed: Apr. 28, 2004

(30) Foreign Application Priority Data
May 8, 2003 (JP) 2003-130670

(51) Int. Cl. G06K 9/54; G06K 9/62; G06F 7/00

(52) U.S. Cl. 382/305; 382/224; 707/3

(57) ABSTRACT

There is provided an image retrieving apparatus comprising image inputting means for inputting an image, attribute value acquiring means for acquiring attribute values, image saving means for saving the image and the attribute values of the image, first retrieving means for determining an image selected from a plurality of images, and retrieving at least one first image similar to the first reference image, retrieved image displaying means for displaying reduced images of the retrieved at least one first image, image selecting means for allowing an image retrieval requester to select at least one second image similar to the first reference image, symbol giving means for newly providing a category, and giving symbols representing the similarity to the category, and numeric value allocating means for giving a numeric value representing the reliability of the similarity.

### CROSS-REFERENCE TO RELATED APPLICATIONS

This application is based upon and claims the benefit of priority from the prior Japanese Patent Application No. 2003-130670, filed May 8, 2003, the entire contents of which are incorporated herein by reference.

### BACKGROUND OF THE INVENTION

1. Field of the Invention

The present invention relates to an image retrieving technique for retrieving a desired image from an image database storing images therein.

2. Description of the Related Art

A description will now be given as to the following two types of methods known as methods for retrieving images.

In a first retrieving method, a keyword reflecting the content of an image is given to that image in advance. Further, in retrieval, an image having the same keyword as that inputted by a user is extracted from an image database and presented.

This retrieving method has a problem that an operation to give an appropriate keyword for each image is troublesome. Furthermore, if a user is different from a person who gave a keyword, there is a case that a reference keyword does not match with a keyword used in the image database even though they are conceptually the same, and there is a problem that non-retrieval occurs.

In a second retrieving method, retrieval is performed by utilizing attribute values obtained by quantifying physical characteristics of an image such as color, shape, and texture thereof. An attribute value of a reference image is compared with that of a retrieved image, and an image with high similarity is extracted from the image database and presented as a retrieval result.

In this retrieving method, since an attribute value extracted based on a predetermined algorithm is not necessarily the same as that of an image that a human feels the same, it is often the case that the similarity between a retrieved image and a reference image is low in terms of human sense. Therefore, a problem that the retrieval accuracy is low is also pointed out.

The following technique has been proposed as a technique to avoid the above-described problem. A characteristic quantity vector and an importance level are obtained with respect to a set of images having the same keyword given thereto in a database. Then, the keyword is converted into an attribute value, and image retrieval is carried out based on this attribute value (Jpn. Pat. Appln. KOKAI Publication No. 2002-140332).

In this retrieving method, however, since a keyword must be given to each image, as is the prior art, great labors is required for a keyword giving operation. Moreover, since there is no guarantee that a distribution of the characteristic quantity vector of images having the same keyword given thereto is sufficiently localized in a characteristic space, similar images cannot be necessarily retrieved with excellent accuracy.

Furthermore, the following technique has been proposed as another technique. Retrieval is executed by using a keyword given to an image, and similar images are retrieved by using an attribute value of the image which is a retrieval result (Jpn. Pat. Appln. KOKAI Publication No. 10-289240).

However, since this retrieving method also uses keywords, giving keywords to images is a great burden. Moreover, since attribute values of images may largely differ in some cases even if these images have the same keyword, a reduction in retrieval accuracy cannot necessarily be solved even if similar images are retrieved based on the attribute value.

### BRIEF SUMMARY OF THE INVENTION

An image retrieving apparatus comprising according to a first aspect of the present invention comprises: image inputting means for inputting an image; attribute value acquiring means for calculating attribute values obtained by quantifying characteristics of an inputted image; image saving means for saving an image and attribute values in association with each other; first retrieving means for determining the image inputted by the image inputting means or an image selected from a plurality of images saved in the image saving means as a first reference image, and retrieving at least one first image similar to the first reference image from the plurality of images saved in the image saving means based on attribute values; retrieved image displaying means for displaying reduced images of the retrieved at least one first image; image selecting means for allowing an image retrieval requester to select at least one second image similar to the first reference image based on the displayed reduced images; symbol giving means for newly providing a category as a data area used to give symbols representing the similarity and the non-similarity with respect to the first reference image to each of all images saved in the image saving means, and giving symbols representing the similarity to the category in accordance with each of the selected at least one second image; and numeric value allocating means for giving a numeric value indicative of the reliability of similarity in accordance with the category.

An image retrieving apparatus according to a second aspect of the present invention comprises: image inputting means for inputting an image; attribute value acquiring means for calculating attribute values obtained by quantifying characteristics of the inputted image; image saving means for saving an image and attribute values of the image in association with each other; first retrieving means for determining an image selected from a plurality of images inputted by the image inputting means or a plurality of images saved in the image saving means as a first reference image, and retrieving at least one first image similar to the first reference image from the plurality of images saved in the image saving means based on attribute values; retrieved image displaying means for displaying reduced images of the retrieved at least one first image; image selecting means for allowing a image retrieval requester to select at least one second image similar to the first reference image based on the displayed reduced images; and numeric value allocating means for newly providing a category as a data area which is used to give a numeric value indicative of the similarity or non-similarity with respect to the first reference image each of all images saved in the image saving means, and giving a numeric value indicative of the reliability of the similarity with respect to the first reference image in accordance with the category for each of the selected at least one second image.

An image retrieving program according to a first aspect of the present invention causes a computer to execute: an image input step of inputting an image; an attribute value acquiring step of acquiring attribute values obtained by quantifying characteristics of the inputted image; an image saving step of saving an image and attribute values of the image in association with each other; a retrieving step of determining an image selected from a plurality of images inputted in the image input step or a plurality of images saved in the image saving step as a first reference image, and retrieving at least one first image similar to the first reference image from the plurality of images saved in the image saving step based on attribute values; a retrieved image displaying step of displaying reduced images of the retrieved at least one first image; an image selecting step of allowing an image retrieval requester to select at least one second image similar to the first reference image based on the displayed reduced images; a symbol giving step of newly providing a category as a data area used to give a symbol representing the similarity or the non-similarity from the first reference image to each of all images saved in the image saving step, and giving a symbol representing the similarity to the category in accordance with each of the selected at least one second image; and a numeric value allocating step of giving a numeric value indicative of the reliability of the similarity in accordance with the category.

An image retrieving program according to a second aspect of the present invention causes a computer to execute: an image input step of inputting an image; an attribute value acquiring step of acquiring attribute values obtained by quantifying characteristics of the inputted image; an image saving step of saving an image and attribute values of the image in association with each other; a retrieving step of determining an image selected from a plurality of images inputted in the image input step or a plurality of images saved in the image saving step as a first reference image, and retrieving at least one first image similar to the first reference image from the plurality of images saved in the image saving step based on attribute values; a retrieved image displaying step of displaying reduced images of the retrieved at least one first image; an image selecting step of allowing an image retrieval requester to select at least one second image similar to the first reference image based on the displayed reduced images; and a numeric value allocating step of newly providing a category as a data area used to give numeric values indicative of the similarity and the non-similarity with respect to the first reference image to each of all images saved in the image saving step, and giving a numeric value indicative of the reliability of the similarity with respect to the first reference image in accordance with the category for each of the selected at least one second image.

Advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a structure of an image retrieving apparatus to which an image retrieving method according to the present invention is applied;

FIG. 2 is a view showing a relation of each function of the image retrieving apparatus when an original image is registered;

FIG. 3 is a flowchart showing a schematic processing procedure when an original image is registered;

FIG. 4 is a view showing a structure of index data;

FIG. 5 is a view showing a relation of each function of the image retrieving apparatus when symbols are given to the original image;

FIG. 6 is a flowchart showing a schematic processing procedure when symbols are given to the original image;

FIG. 7 is a view showing a structure of a symbol area;

FIG. 8 is a view showing a relation of each function of an image retrieving method according to an image retrieving apparatus of a first embodiment;

FIG. 9 is a flowchart showing a schematic processing procedure of the image retrieving method according to the image retrieving apparatus of the first embodiment;

FIG. 10 is a view illustrating an addition method;

FIG. 11 is a view showing a relation of each function of an image retrieving method according to an image retrieving apparatus of a second embodiment;

FIG. 12 is a flowchart showing a schematic processing procedure of the image retrieving method according to the image retrieving apparatus of the second embodiment;

FIG. 13 is a view showing a relation of each function of an image retrieving method according to an image retrieving apparatus of a third embodiment;

FIG. 14 is a flowchart showing a schematic processing procedure of the image retrieving method according to the image retrieving apparatus of the third embodiment; and

FIG. 15 is a flowchart showing a processing procedure of clustering.

### DETAILED DESCRIPTION OF THE INVENTION

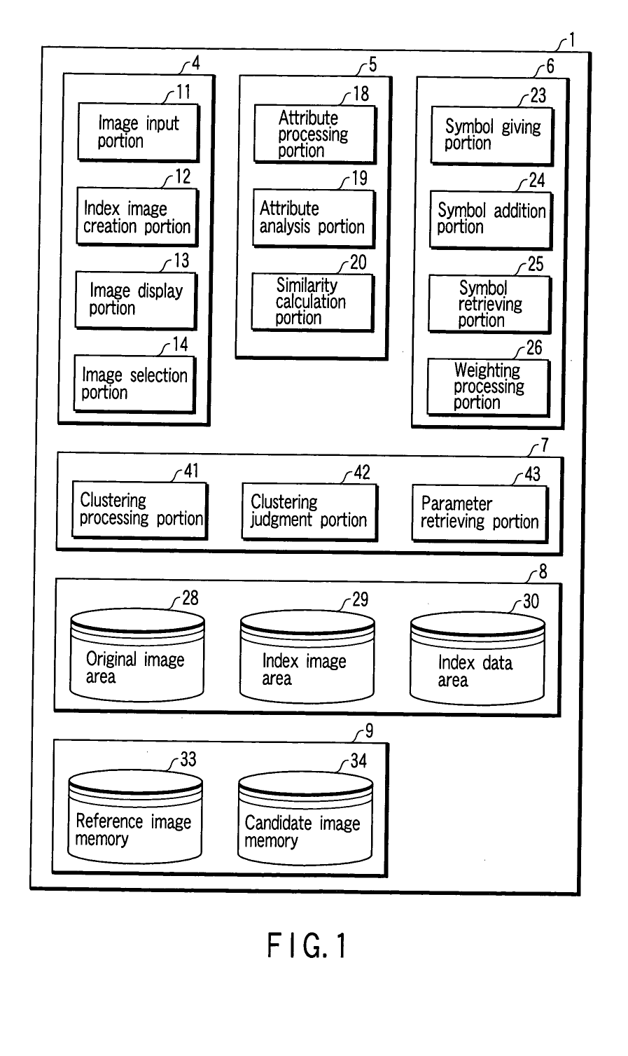

FIG. 1 is a block diagram showing a structure of an image retrieving apparatus of a first embodiment according to the present invention. An image as a retrieval target will be referred to as an “original image” hereinafter.

An image retrieving apparatus 1 comprises an image processing portion 4, an attribute processing portion 5, a symbol processing portion 6, a cluster analysis portion 7, an image database 8, and a buffer memory 9.

The image processing portion 4 processes image data. The attribute processing portion 5 processes attribute data of images. The symbol processing portion 6 processes symbols each representing whether an image belongs to a given category. The cluster analysis portion 7 performs cluster analysis of images. The image database 8 is a storage area for original images. The buffer memory 9 is a storage area for any other data.

In the image processing portion 4 are provided an image input portion 11, an index image creation portion 12, an image display portion 13 and an image selection portion 14.

The image input portion 11 fetches an original image from an image input device (not shown) into the image retrieving apparatus 1. The index image creation portion 12 creates an index image as a reduced image of each original image stored in the image database 8. The image display portion 13 displays an index image or an original image in a display device (not shown). The image selection portion 14 supports an image selection operation by a user.

To the attribute processing portion 5 are provided an attribute processing portion 18, an attribute analysis portion 19 and a similarity calculation portion 20.

The attribute processing portion 18 obtains attribute values of an original image. The attribute analysis portion 19 extracts various attribute values from an original image in subordination to the attribute processing portion 18. The similarity calculation portion 20 calculates an index used to judge the similarity or the non-similarity between images based on attribute values.

To the symbol processing portion 6 are provided a symbol giving portion 23, a symbol addition portion 24, a symbol retrieving portion 25, and a weighting processing portion 26.

The symbol giving portion 23 gives the same symbol to all original images which have the similarity to a reference image and are selected by the image selection portion based on index images displayed in the image display portion 13. When an original image is similar to a reference image, it is determined that it belongs to a category similar to this reference image, and “1” is given to a specific digit in a symbol area given to each original image in connection with the reference image, for example. It is to be noted that, e.g., “0” is given to the digit of the same category in the storage area if the original image is not similar to this reference image. The symbol addition portion 24 performs an addition calculation of symbols of a plurality of original images. The symbol retrieving portion 25 retrieves an original image having a predetermined symbol set to “1”. The weighting processing portion 26 sets a weighting coefficient to be used in the addition calculation of symbols, and performs a multiplication calculation of weighting.

To the cluster analysis portion 7 are provided a clustering processing portion 41, a clustering judgment portion 42, and a parameter retrieving portion 43.

The clustering processing portion 41 classifies images into clusters based on attribute values. The clustering judgment portion 42 judges whether a localized cluster exist. The parameter retrieving portion 43 retrieves an image having a predetermined attribute.

To the image database 8 are provided an original image area 28, an index image area 29, and an index data area 30.

An original image as a retrieval target is stored in the original image area 28. An index image obtained by reducing each original image is stored in the index image area 29. An original image, an address to access an index image, and information such as attribute values of the original image are stored in the index data area 30.

The buffer memory 9 includes a reference image memory 33 which stores a reference image as an image which becomes a reference at the time of image retrieval, and a candidate index memory 34 which stores a storage address of an original image selected at a middle stage of retrieval.

An operation of this image retrieving apparatus 1 will now be described.

A user registers an original image with respect to the image retrieving apparatus 1 as an operation on a preliminary stage.

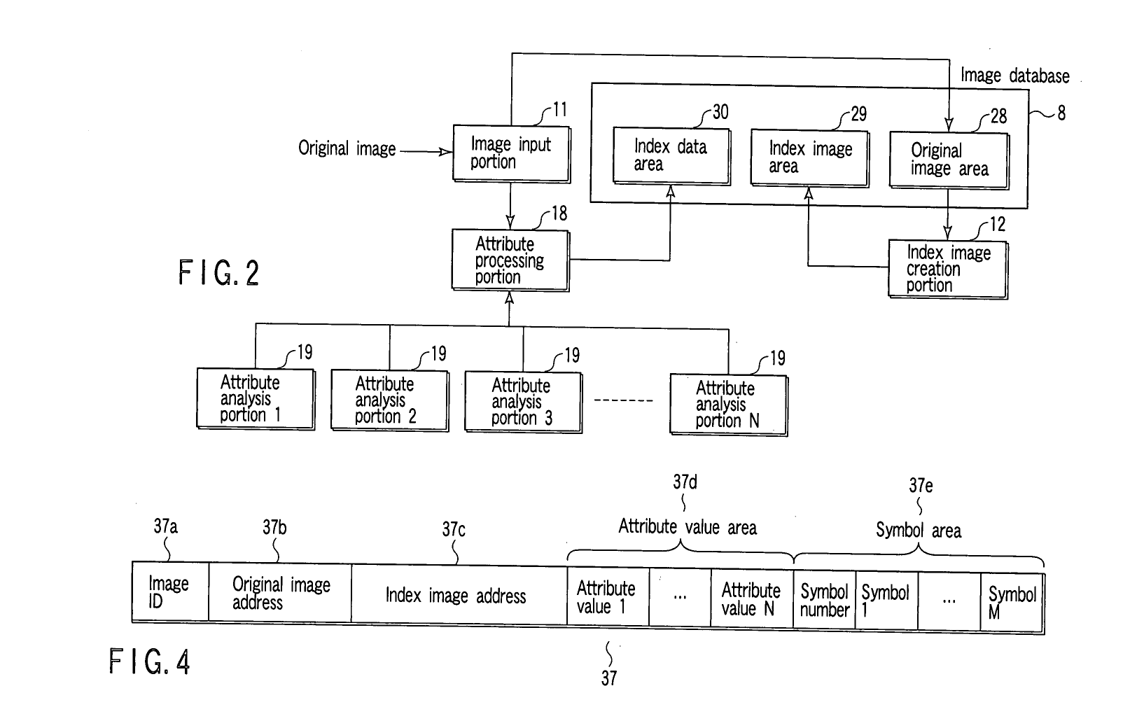

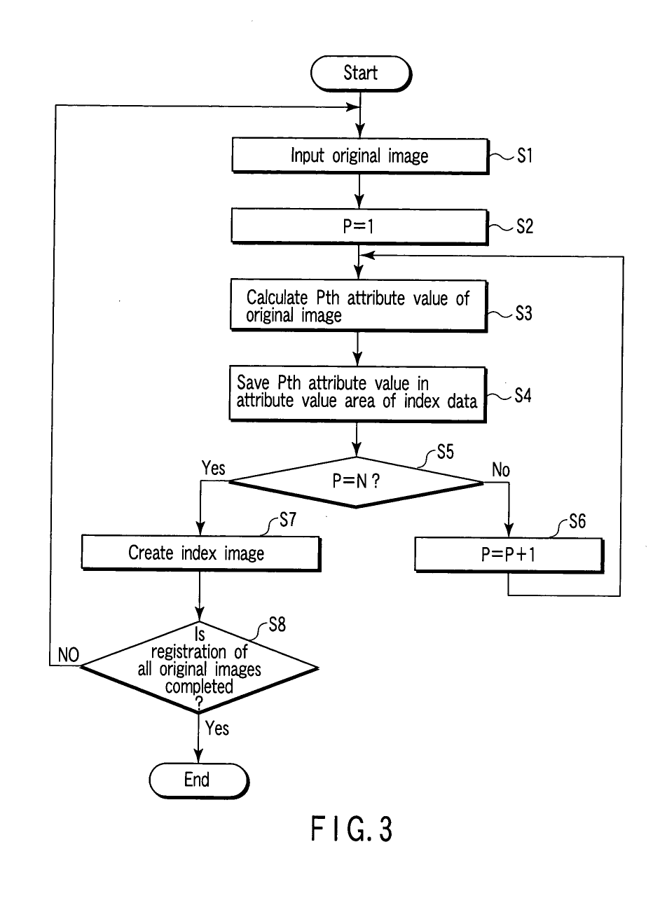

FIG. 2 is a view showing a relation of each function of the image retrieving apparatus when registering an original image. FIG. 3 is a flowchart showing a schematic processing procedure when registering an original image.

In step S1, the image input portion 11 reads an original image from the image input device (not shown). Then, the image input portion 11 stores the read original image in the original image area 28 in the image database 8, and activates the attribute processing portion 18.

In step S2, the attribute processing portion 18 sets a control variable P to an initial value 1, and activates the Pth attribute analysis portion 19.

In step S3, the Pth attribute analysis portion 19 obtains a Pth attribute value about the read original image. Here, the attribute value of the original image is a value obtained by digitalizing physical attributes of the image such as color, shape, texture or the like represented in the original image. Therefore, the attribute value used herein corresponds to a quantity represented by quantifying physical constituent elements such as color or shape, and it is not a value based on a sensuous element obtained from the human subjectivity.

In step S4, the attribute processing portion 18 stores the attribute value P obtained by the Pth attribute analysis portion 19 in the attribute value area for index data 37 saved in the index data area 30.

FIG. 4 is a view showing a structure of the index data 37.

To the index data 37 are provided an image ID 37a, an original image address 37b, an index image address 37c, an attribute value area 37d, and a symbol area 37e.

The image ID 37a specifies an original image. The original image address 37b is indicative of an address in the original image area 28 at which an original image is stored. The index image address 37c is indicative of an address in the index image area 29 at which an index image as a reduced image of an original image is stored. The attribute value area 37d stores a plurality of attribute values of an original image. The symbol area 37e stores symbols each corresponding to a category given to an original image and the number of all the symbols.

Here, the “category” means a symbol which is used to identify an image which is determined to be visually equal to a reference image presented by a user, and it is set in accordance with each reference image which will be described later. The description that the original image belongs to a Jth category means that the original image is visually similar to a Jth reference image presented by a user, and a “symbol J” in the symbol area 37e is 1.

In step S5, whether all of the predetermined number N of attribute values are obtained is checked. If No in step S5, i.e., if the predetermined number N of attribute values are yet to be obtained, the control variable P is counted up in step S6, and the processing from step S3 to step S4 is repeated.

If Yes in step S5, i.e., if the predetermined number N of attribute values are obtained, the index image creation portion 12 creates an index image which is a reduced image of the original image based on the original image and stores it in the index image area 29, and an index image address 37c of the index data 37 is updated in step S7.

In step S8, whether registration of all original images is completed is checked. If No in step S8, i.e., if images to be registered still remain, the processing from step S1 to step S7 is repeated.

If Yes in step S8, i.e., if registration of all images is completed, the image registration processing is terminated. It is to be noted that registration of original images does not have to be performed all at once, and it is repeated according to needs.

Subsequently, a user gives symbols in accordance with each original image registered in the image retrieving apparatus 1. Here, the “symbol” used in the present invention is a concept similar to a conventional keyword, but it is a dominant concept which is broader than the keyword. That is, the keyword represents characteristics of an image based on a “word”, whereas the “symbol” does not conceptualize and restrict such characteristics based on a word, but it is used to group them based on the visual similarity of an image. An image determined to have the similarity is represented as belonging to the same category, and 1 is stored in the same digit in the symbol area 37e. Each digit excluding the symbol number in the symbol area 37e indicates each category.

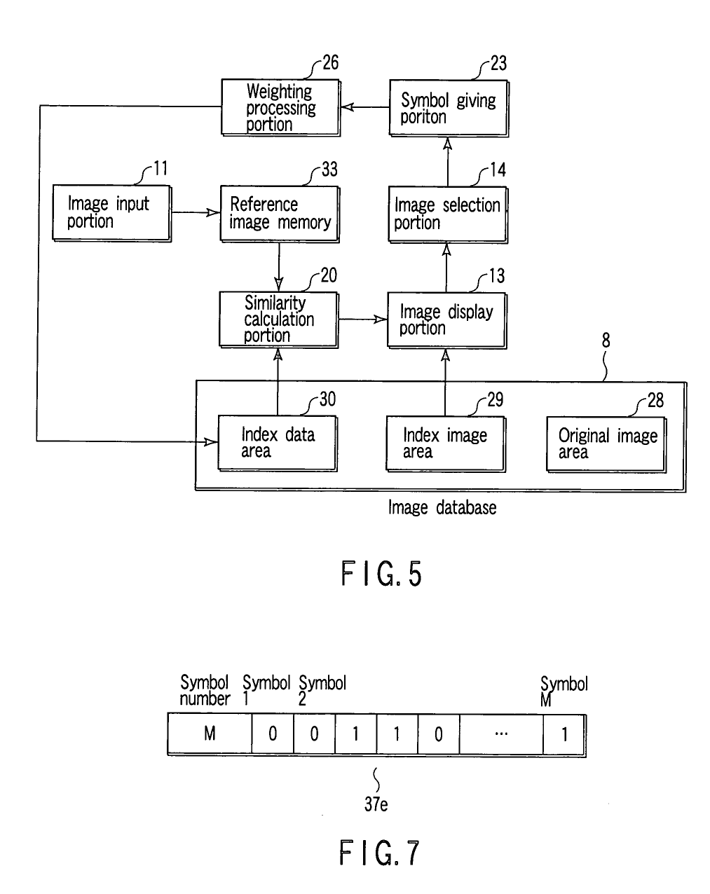

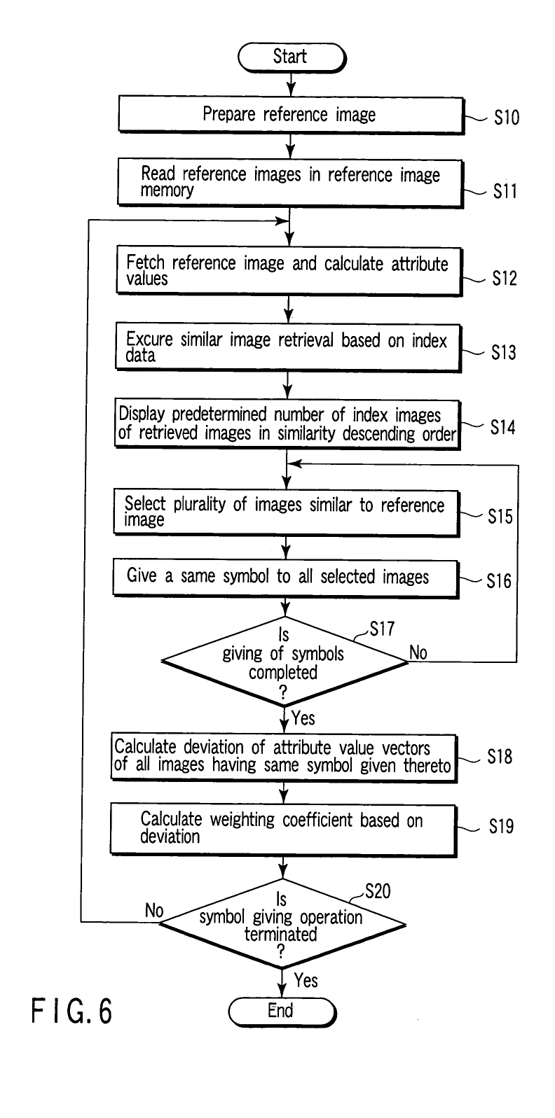

FIG. 5 is a view showing a relation of each function of the image retrieving apparatus when giving symbols to an original image. FIG. 6 is a flowchart showing a schematic processing procedure when giving symbols to an original image.

In step S10, a user prepares a reference image which can be a criterion when giving symbols to an original image. Here, the reference image can substitute for the conventional keyword, and the following processing give an original image a symbol indicating whether an original image is similar to the reference image.

In step S11, the image input portion 11 reads one or more reference images from the image input device (not shown). Then, the image input portion 11 stores the read reference images in the reference image memory 33 of the buffer memory 9. It is to be noted that the reference images may be selected from original images stored in the original image area 28 of the image database instead of reading from the image input device (not shown).

In step S12, the similarity calculation portion 20 fetches the reference image from the reference image memory 33, and calculates the above-described attribute values with respect to this reference image. That is, it obtains a plurality of attribute values processed in the attribute analysis portion 19 in accordance with the procedure in steps S3 and S4 mentioned above.

In step S13, the similarity calculation portion 20 calculates a similarity based on the index data 37 stored in the index data area 30, and specifies an original image similar to the reference image. A judgment on the similarity is carried out by comparing a plurality of attribute values 1 to N of the reference image and the original image. For example, functions using the attribute values 1 to N as parameters are set. If a function value of the reference image is approximate to a function value of the original image, it can be determined that this original image is similar to the reference image. Moreover, original images are sequenced in the similarity descending order.

In step S14, the image display portion 13 fetches index images of the original images specified in the similarity descending order from the index image area 29, and displays a predetermined number of fetched images on the display device (not shown). Then, it outputs a direction to urge a user to perform selection.

In step S15, the user sees the displayed index images, and selects a plurality of (one or zero is possible) of original images which are determined to be similar to the reference image. The image selection portion 14 supports the selection operation of the user, and fetches information about the selected images.

In step S16, the symbol giving portion 23 gives a symbol to the symbol areas 37e in the index data 37 with respect to each selected original image.

FIG. 7 is a view showing a structure of a symbol area 37e. The symbol giving portion 23 adds 1 to the “symbol number” in the symbol area 37e of each selected original image to determine the symbol number as M, and writes a numeric figure “1” at a position of a newly provided “symbol M”. Further, the symbol giving portion 23 adds 1 to the “symbol number” in the symbol area 37e of each non-selected original image and determines the symbol number as M, and writes a numeric figure “0” at a position of a newly provided “symbol M”.

In step S17, a judgment is made upon whether symbol grant is terminated if giving a plurality of symbols is possible with respect to one reference image.

Even if the number of reference image is one, when a plurality of subjects are shown in the image, a different symbol can be given to each subject. Additionally, even if only a single subject is shown by changing a point of observation, a plurality of symbols can be given. For example, color and shape can be regarded as different matters, and different symbols can be given. Further, if No in step S17, i.e., if symbol grant is not terminated, the processing from step S15 to step S16 is repeated.

If Yes in step S17, i.e., if symbol grant is terminated, a weighting coefficient used in later-described addition processing is calculated.

The weighting processing portion 26 makes reference to the attribute value area 37d in the index data 37 with respect to each image having “1” written at a position of the “symbol M” thereof. Then, an attribute value vector Xi (i=1 to K) using attribute values 1 to N as elements is defined. Here, K means that the number of images having “1” written at a position of the “symbol M” is K.

Further, in step S18, each element (attribute value) of the attribute value vector Xi is determined as xij (j=1 to N), and a deviation σj shown in Expression (1) is calculated in accordance with each attribute value.

$${σ}_{j} = \sqrt{\frac{{\sum }_{i = 1}^{K} {( {x}_{ij} - {\overline{x}}_{j} )}^{2}}{K}} \qquad Expression ( 1 )$$

where K: the number of images, xij: element of the attribute vector Xi, N: the number of attribute values, and xj: average value of the jth attribute values.

In step S19, the weighting processing portion 26 calculates a weighting coefficient based on the deviation σj (j=1 to N). At this time, the weighting coefficient is calculated to be a small value if the deviation is large, and the weighting coefficient is calculated to be a large value if the deviation is small.

When the deviation is large, it means that dispersion in attribute values of images having “1” written at the position of the “symbol M” thereof is large. Therefore, it can be considered that the impact of the attribute values on the similarity, in other words, the reliability of the similarity is low. Accordingly, it can be considered that a level that the symbol at this position contributes to the similarity is low, and it is proper to set the weighting coefficient to a relatively small value.

Conversely, when the deviation is small, it means that dispersion in attribute values of images having “1” written at the position of the “symbol M” is small. Therefore, it can be considered that the impact of the attribute values on the similarity, in other words, the reliability of the similarity is high. Accordingly, it can be considered that a level that the symbol at this position contributes to the similarity is relatively high, and it is proper to set the weighting coefficient to a relatively large value.

It is to be noted that the weighting coefficient may be defined by, e.g., an inverse number of the deviation as long as it can satisfy the above-described relationship, and, in general, a function using the deviation σj (j=1 to N) as a parameter may be set and the weighting coefficient may be defined by using this function value. Further, a statistic representing dispersion in attribute values may be obtained, and the weighting coefficient may be calculated based on this value without using the deviation. For example, it is possible to use a difference between the maximum value and the minimum value.

Furthermore, when calculating the weighting coefficient, it is preferable to perform the above-described calculation after normalizing each attribute value in order to eliminate individual differences between the attribute values. The weighting coefficient concerning the calculated category M is stored in the index data area.

In step S20, whether the symbol giving operation is terminated is checked. For example, whether the symbol giving processing is terminated with respect to all the reference images is checked.

If No in step S20, i.e., if unprocessed reference images remain, the processing from step S12 to step S19 is repeated. If Yes in step S20, i.e., if the symbol giving processing is terminated with respect to all the reference images, this symbol giving processing is terminated.

It is to be noted that “1” and “0” are used as the symbols in this embodiment, but the present invention is not restricted to this conformation. The symbols may be alphabetic characters or special characters, and they do not have to be meaningful in particular. Moreover, what kind of subject or what kind of subject property each of the symbols 1 to M represents is unnecessary information. This point is essentially different from the keyword mode which requires a specific meaning content in the keyword itself.

Additionally, this embodiment is characterized in that not only the similarity or the non-similarity is quantitatively judged based on the attribute values but also a similarity result with respect to a reference image obtained by a human visual judgment is fetched as a symbol. In general, it can be considered that subjective elements have a great impact on the similarity or the non-similarity of images. If so, it is possible to provide a result which is close to the subjectivity of a user who uses this image retrieving apparatus 1 by configuring this apparatus to add the human visual judgment as well as a mechanical judgment based on digitalized physical data of images.

Further, in this embodiment, a numeric figure written in the “symbol number” shown in FIG. 7 is incremented by 1 every time the reference image is read and the symbol giving processing is executed, and the data area used to give a symbol, i.e., the category is increased. This means that symbol information characterizing an image is constituted to grow as selection of images similar to a reference image is repeated. Therefore, the effect that the retrieval accuracy is improved as the number of similarity judgment is increased can be expected.

On the other hand, although this embodiment is characterized in that a keyword is not used, but the processing from step S10 to step S16 can be applied to the keyword grant in the conventional keyword retrieval. By giving the same keyword to images selected in steps S10 to S15, the keyword can be easily given as compared with a case of giving the keyword to each image.

An image retrieving method will now be described.

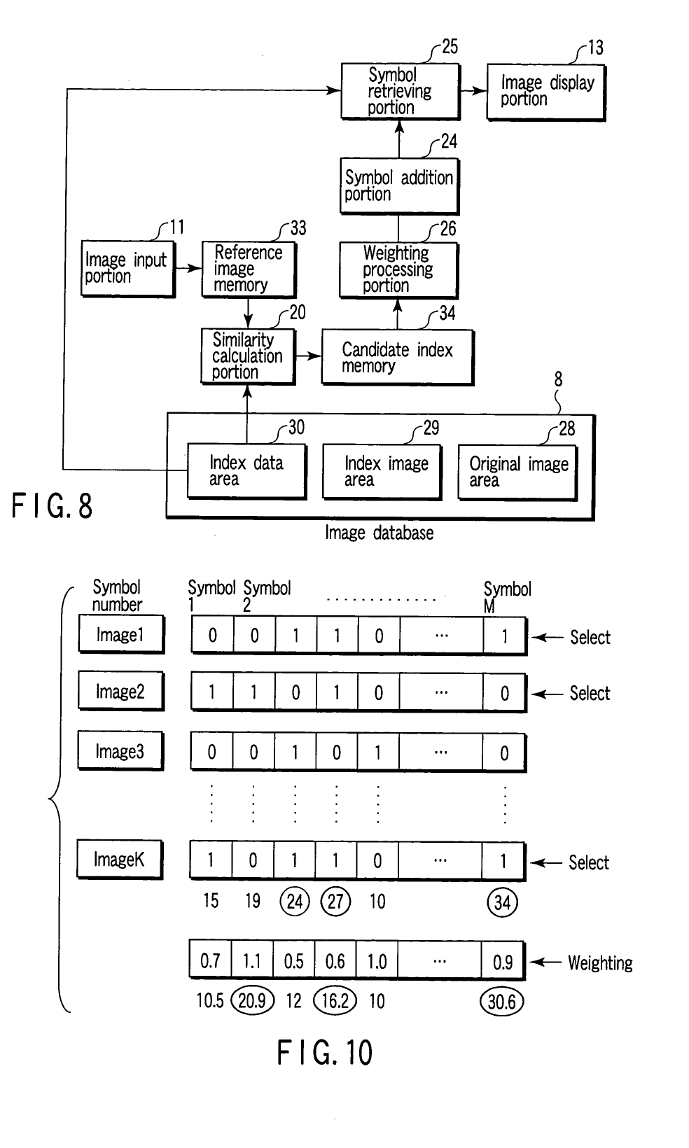

FIG. 8 is a view showing a relation of each function of an image retrieving method according to the image retrieving apparatus of the first embodiment. FIG. 9 is a flowchart showing a schematic processing procedure of the image retrieving method according to the image retrieving apparatus of the first embodiment.

In step S21, a user prepares a reference image similar to an image to be retrieved. The image input portion 11 reads a reference image from the image input device (not shown). Then, the image input portion 11 stores the read reference image in the reference image memory 33 of the buffer memory 9. It is to be noted the reference image may be selected from images stored in the reference image memory 33 in advance or an original image stored in the original image area 28 may be selected as the reference image in place of reading the reference image from the image input device (not shown).

In step S22, the similarity calculation portion 20 fetches the reference image from the reference image memory 33, and calculates the above-described attribute values with respect to this reference image. That is, it obtains a plurality of attribute values processed in the attribute analysis portion 19 in accordance with the procedures of steps S3 and S4 mentioned above.

In step S23, the similarity calculation portion 20 selects original images similar to the reference image based on the index data 37 stored in the index data area 30.

A judgment on the similarity is carried out based on magnitudes of the similarity obtained as functions of a plurality of attribute values 1 to N of each of the reference image and the original image. For example, all of the attribute values 1 to N of the reference image are determined as an attribute value vector V of the reference image, an attribute value vector of the hth original image is likewise determined as Uh, and the similarity Dh is calculated by using Expression (2).
Dh=(Uh−V)(Uh−V) Expression (2)

It is to be noted that an operator “-” represents an inner product of the vector shown in Expression (3).
W·V=W1×V1+W2×V2+ . . . +WN×VN Expression (3)

Dh in Expression (2) represents a square of a Euclid distance between the attribute vector of the hth original image and the attribute vector of the reference image, and this becomes an index of the similarity. That is, the similarity becomes large as the distance is small (Dh is small).

Furthermore, a distance may be calculated by weighting each attribute, and a result is determined as an attribute value, thereby correcting a difference in characteristics between the respective attribute values (e.g., colors and shapes). As a result, a further proper index of the similarity can be obtained.

In this case, the weighting vector representing a weighting of each attribute is determined as W, and the similarity Dh is represented by Expression (4).
Dh=(W*Uh−W*V)(W*Uh−W*V) Expression (4)

It is to be noted that “*” is an operator of the vector having as an element a value obtained by performing the multiplication in accordance with each element of the two vectors shown in Expression (5).
W*V=(W1×V1,W2×V2, . . . ,WN×VN) Expression (5)

As to the weighting, it can be obtained by applying the arithmetic operation processing which is used to calculate the weighting coefficient described in steps S18 and S19. For example, an inverse number of the deviation of each attribute value sample obtained from many sample images is used.

Moreover, the similarity calculation portion 20 sorts the index data 37 of the plurality of selected original images (which will be referred to as “primary selected images” hereinafter) in the similarity descending order, and stores them as candidate index data in the candidate index memory 34.

In step S24, the symbol addition portion 24 fetches the index data 37 from the candidate index memory 34 with respect to the top to the Kth images having the high similarity among the primary selected images, and adds data having the same symbol given thereto (“1” or “0” in this embodiment) in the symbol area 37e. Then, the weighting processing portion 26 multiplies this addition result by the weighting coefficient, thereby calculating a count value.

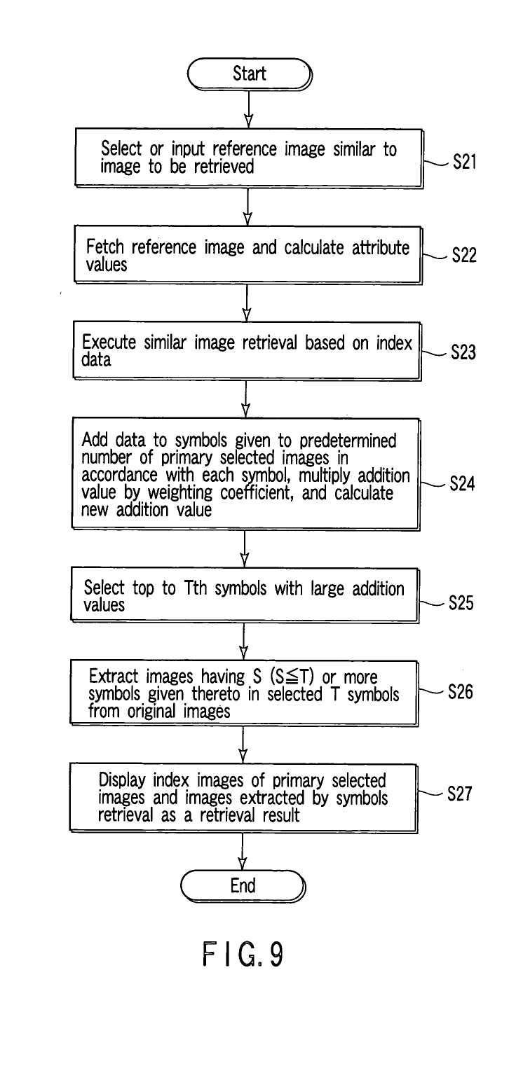

FIG. 10 is a view illustrating an addition method.

FIG. 10 shows the symbol 1 to the symbol M in the symbol area 37e corresponding to Image1 to ImageK which are the superior K original images. The symbol addition portion 24 adds the data in accordance with each of the symbol 1 to the symbol M. That is, the number of the original images similar to the category represented by each of the symbols 1 to M is calculated in accordance with each of the symbols 1 to M. A lower column in FIG. 10 shows results of addition.

Then, the weighting processing portion 26 calculates a new addition value obtained by multiplying this addition result by the weighting coefficient. The weighting coefficient used here is a value obtained in steps S18 and S19, and this value is set in accordance with each of the symbols 1 to M. The lowest column in FIG. 10 shows new addition values after correction.

That is, in case of the symbol 1, the original addition value 15 is changed to a new addition value 10.5 by being multiplied by the weighting coefficient 0.7. Likewise, in case of the symbol 2, the original addition value 19 is changed to a new addition value 20.9 by being multiplied by the weighting coefficient 1.1.

In step S25, the symbol addition portion 24 selects the superior first to Tth symbols based on the new addition values. If T=3, the symbol 2, the symbol 4 and the symbol M are selected as shown in FIG. 10.

This means that many of the original images which are considered to be “very” similar to the reference image have visual characteristics represented by the symbol 2, the symbol 4 and the symbol M. That is, it is determined that the original images having the visual characteristics represented by the symbol 2, the symbol 4 and the symbol M have the high possibility that they are similar to the reference image.

It is to be noted that the symbols and the weightings are separately processed in this embodiment, but symbols including weightings may be used in place of utilizing 0 or 1 as symbols. In this case, weighted symbols are stored in the symbol area 37e, and the weighting processing is terminated by just performing the addition processing to a value of each weighted symbol in the symbol addition portion 24. Therefore, the weighting processing portion 26 is no longer necessary.

In step S26, the symbol retrieving portion 25 retrieves original images each having at least S symbols being set to “1” among the T selected symbols based on the index data 33. Additionally, the images retrieved based on the symbols are determined as images which are not selected as the primary selected images in the original images. That is, the original images selected based on the attribute values as well as the original image retrieved based on the symbols are extracted as images similar to the reference image. It is to be noted that such a mode to select images based on symbols will be referred to as a symbol retrieving mode.

In step S27, the image display portion 13 displays the index images of the primary selected images and the images extracted by the symbol retrieving mode as a retrieval result in a display device (not shown).

According to the image retrieving apparatus of the first embodiment, since similar images are retrieved by combining the retrieval based on attribute values and the symbol retrieval, the retrieval accuracy can be increased. That is, since the retrieval based on attribute values judges the similarity based on physical constituent elements such as color, shape and others, similar images selected based on only these criteria are not necessarily images that human visually feels the similarity. Thus, by also adopting the symbol retrieving mode which brings in sensuous elements based on a human subjectivity and judges the similarity, missing in similar image retrieval can be reduced, and the retrieval accuracy can be improved.

Further, since the weighting coefficient based on attribute values is adopted, the similar image retrieval with the high accuracy can be effected.

A description will now be given as to an image retrieving apparatus of a second embodiment according to the present invention. Since a structure of the image retrieving apparatus of the second embodiment is the same as that of the image retrieving apparatus of the first embodiment depicted in FIG. 1, like reference numerals denote like parts, thereby eliminating the illustration and the detailed explanation.

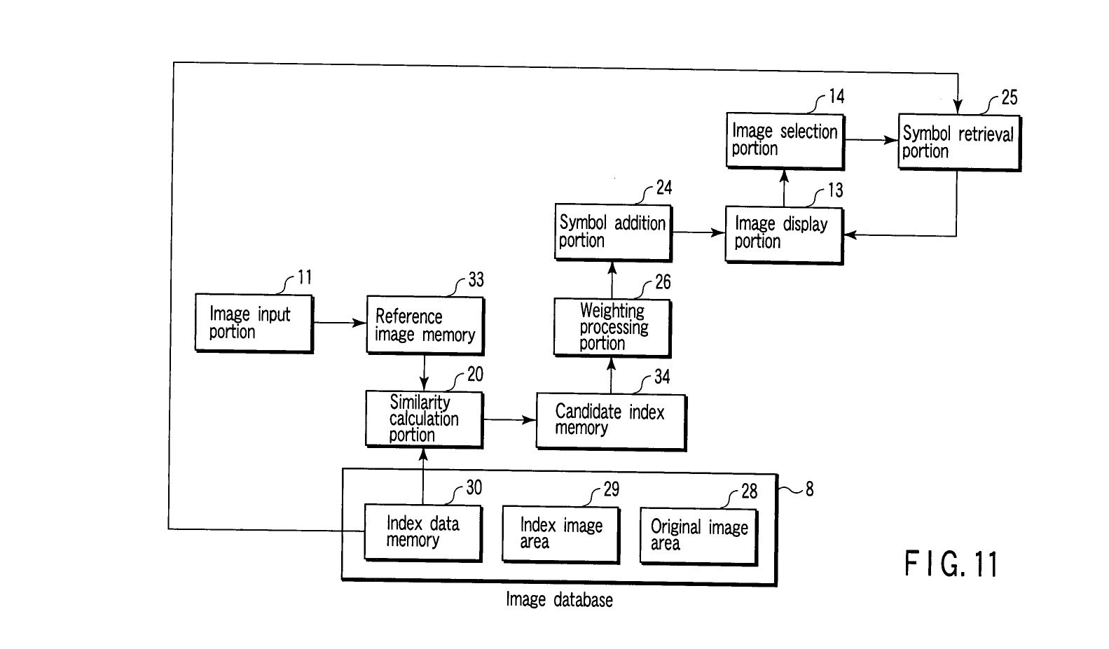

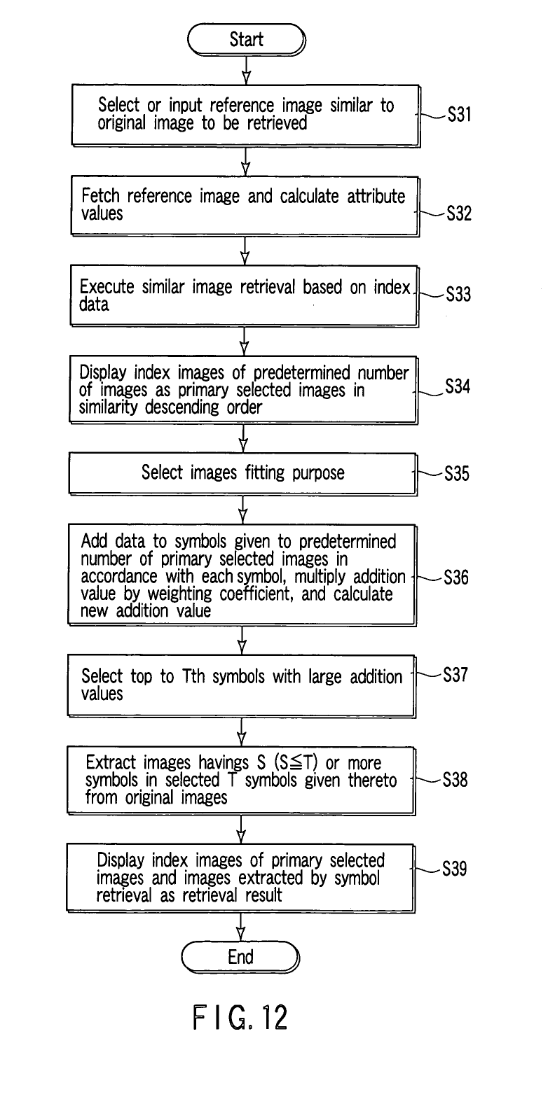

FIG. 11 is a view showing a relation of each function of an image retrieving method according to the image retrieving apparatus of the second embodiment. FIG. 12 is a flowchart showing a schematic processing procedure of the image retrieving method according to the image retrieving apparatus of the second embodiment.

In step S31, a user prepares a reference image similar to an original image to be retrieved. An image input portion 11 reads the reference image from an image input device (not shown). Then, the image input portion 11 stores the read reference image in a reference image memory 33 of a buffer memory 9. It is to be noted that a reference image may be selected from those stored in the reference-image memory 33 in advance or an original image stored in an original image area 28 may be selected as a reference image in place of reading a reference image from the image input device (not shown).

In step S32, a similarity calculation portion 20 fetches the reference image from the reference image memory 33, and calculates the above-described attribute values with respect to this reference image. That is, a plurality of attribute values processed in an attribute analysis portion 19 are obtained in accordance with a procedure in steps S3 and S4 mentioned above.

In step S33, the similarity calculation portion 20 selects original images similar to the reference image based on index data 37 stored in an index data area 30. A judgment on the similarity is made by the same method as that in the first embodiment.

Furthermore, the similarity calculation portion 20 sorts the index data 37 of the plurality of primary selected images in the similarity descending order, and store them in a candidate index memory 34.

In step S34, an image display portion 13 displays index images of the primary selected images on a display device (not shown) as a retrieval result.

In step S35, a user sees the displayed index images, and selects a plurality of images which are determined to be similar to the reference image. However, the number of the images to be selected may be one. An image selection portion 14 supports the selection operation of the user, and fetches information about the selected images. Incidentally, when the number of the selected images is zero, this is regarded as being equal to selection of all the displayed images and processing is carried out.

In step S36, a symbol addition portion 24 aims at the original images selected by the user, fetches the index data 37 from the candidate index memory 34 and adds data of the same symbol in a symbol area 37e, and a weighting processing portion 26 calculates a count value by multiplying the addition value by a weighting coefficient. It is to be noted that the addition method is the same as that described in conjunction with the retrieving method of the first embodiment, and hence the detailed explanation is eliminated.

In step S37, the symbol addition portion 24 selects a top symbol to a Tth symbol having large addition result numeric figures.

In step S38, a symbol retrieving portion 25 retrieves original images having at least S symbols being set to “1” in the selected T symbols based on the index data 37. Moreover, the images to be retrieved based on the symbols are determined as images which are not selected as the primary selected images in the original images.

In step S39, the image display portion 13 displays index images of the primary selected images and the original images extracted by the symbol retrieval on the display device (not shown) as a retrieval result.

According to the image retrieving apparatus of the second embodiment, since similar images are selected based on a human visual sensation from the primary selected images and the symbol retrieving mode is applied based on the selected images, the accuracy of the similar image retrieval based on the symbol retrieval can be further improved.

An image retrieving apparatus of a third embodiment according to the present invention will now be described. Since a structure of the image retrieving apparatus according to the third embodiment is the same as that of the image retrieving apparatus of the first embodiment illustrated in FIG. 1, like reference numerals denote like parts, thereby eliminating the illustration and the detailed explanation.

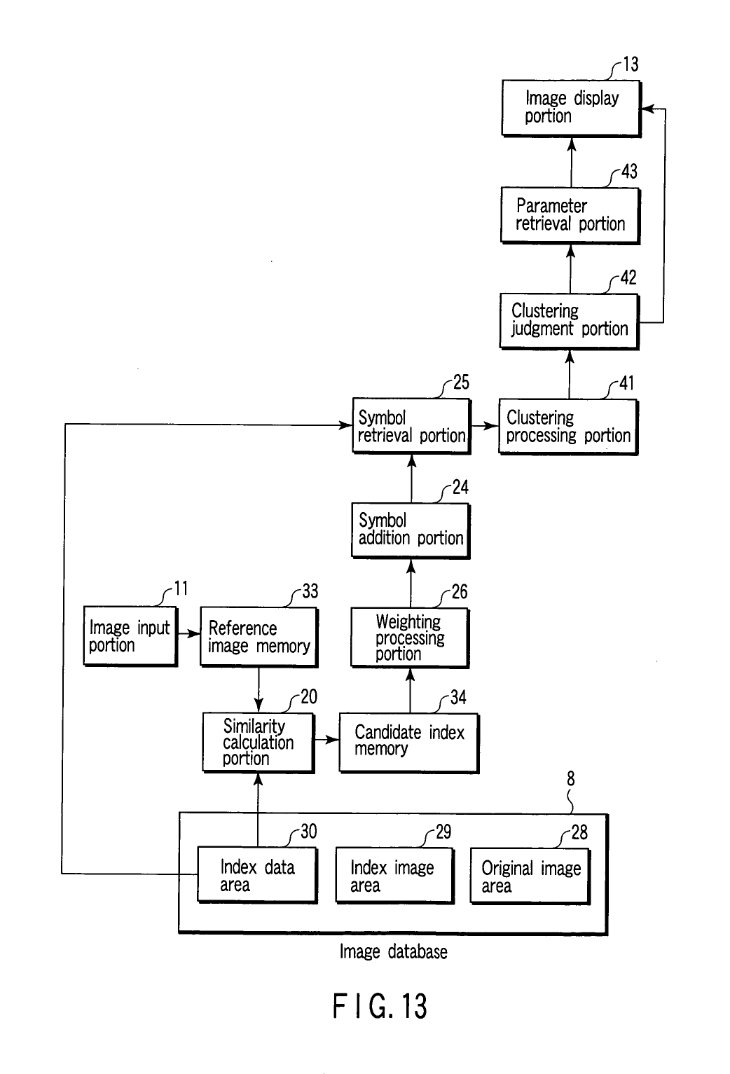

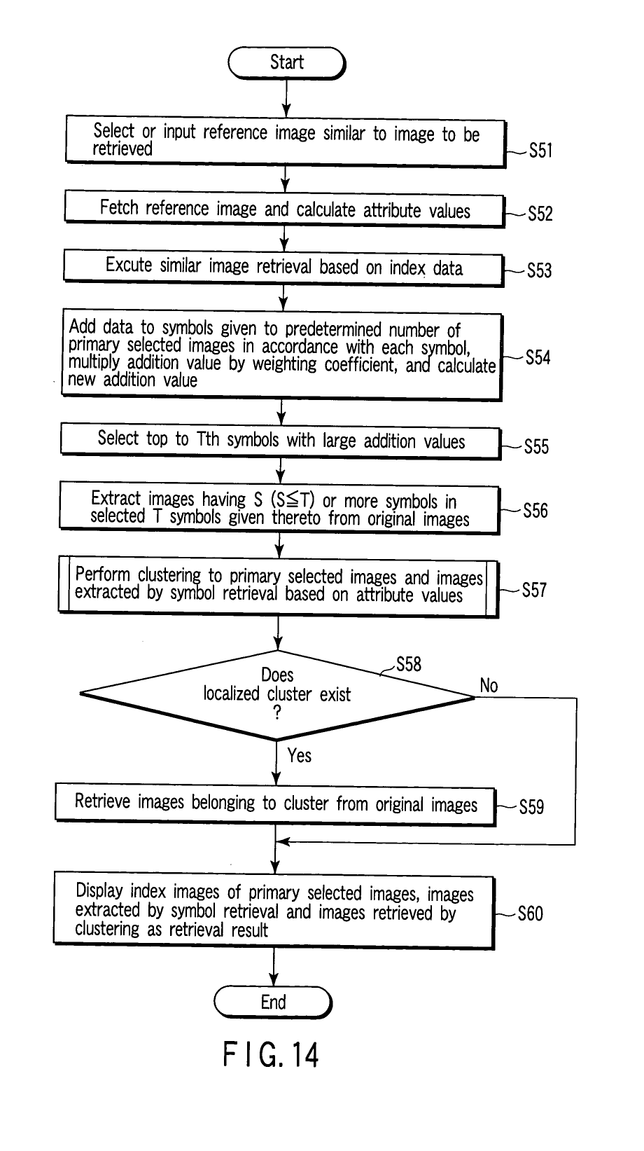

FIG. 13 is a view showing a relation of each function of an image retrieving method according to the image retrieving apparatus of the third embodiment. FIG. 14 is a flowchart showing a schematic processing procedure of the image retrieving method according to the image retrieving apparatus of the third embodiment.

In step S51, a user prepares a reference image similar to an image to be retrieved. An image input portion 11 reads a reference image from an image input device (not shown). Then, the image input portion 11 stores the read reference image in a reference image memory 33 of a buffer memory 9. It is to be noted that a reference image may be selected from those stored in the reference image memory 33 in advance or an original image stored in an original image area 28 may be selected as a reference image instead of reading a reference image from the image input device (not shown).

In step S52, a similarity calculation portion 20 fetches the reference image from the reference image memory 33, and calculates the above-described attribute values about this reference image. That is, a plurality of attribute values processed in an attribute analysis portion 19 are obtained in accordance with the procedure in steps S3 and S4 mentioned above.

In step S53, the similarity calculation portion 20 selects original images similar to the reference image based on index data 37 stored in an index data area 30. The similarity judgment method is the same as step S23.

Then, the similarity calculation portion 20 sorts the index data 37 of the plurality of selected original images (which will be referred to as “primary selected images” hereinafter) in the similarity descending order, and stores them as candidate index data in a candidate index memory 34.

In step S54, a symbol addition portion 24 aims at the top to Kth images with the high similarity in the primary selected images, fetches the index data 37 from the candidate index memory 34, and adds data given to the same symbol in a symbol area 37e. In this embodiment, “1” or “0” is added. Further, a weighting processing portion 26 calculates a count value by multiplying this addition result by a weighting coefficient. The count value calculation method is the same as step S24.

In step S55, the symbol addition portion 24 selects the top to Tth symbols with the large new addition values. If T=3, a symbol 2, a symbol 4 and a symbol M are selected as shown in FIG. 10.

In step S56, a symbol retrieving portion 25 retrieves original images having at least S symbols being set to “1” in the T selected symbols based on the index data 33. Furthermore, the images to be retrieved based on the symbols are images which are not selected as the primary selected images. That is, the original images selected based on the attribute values as well as the original images retrieved based on the symbols are extracted as images similar to the reference image.

In step S57, a clustering processing portion 41 classifies (clustering) the primary selected images and the images extracted by the symbol retrieval mode based on the attribute values.

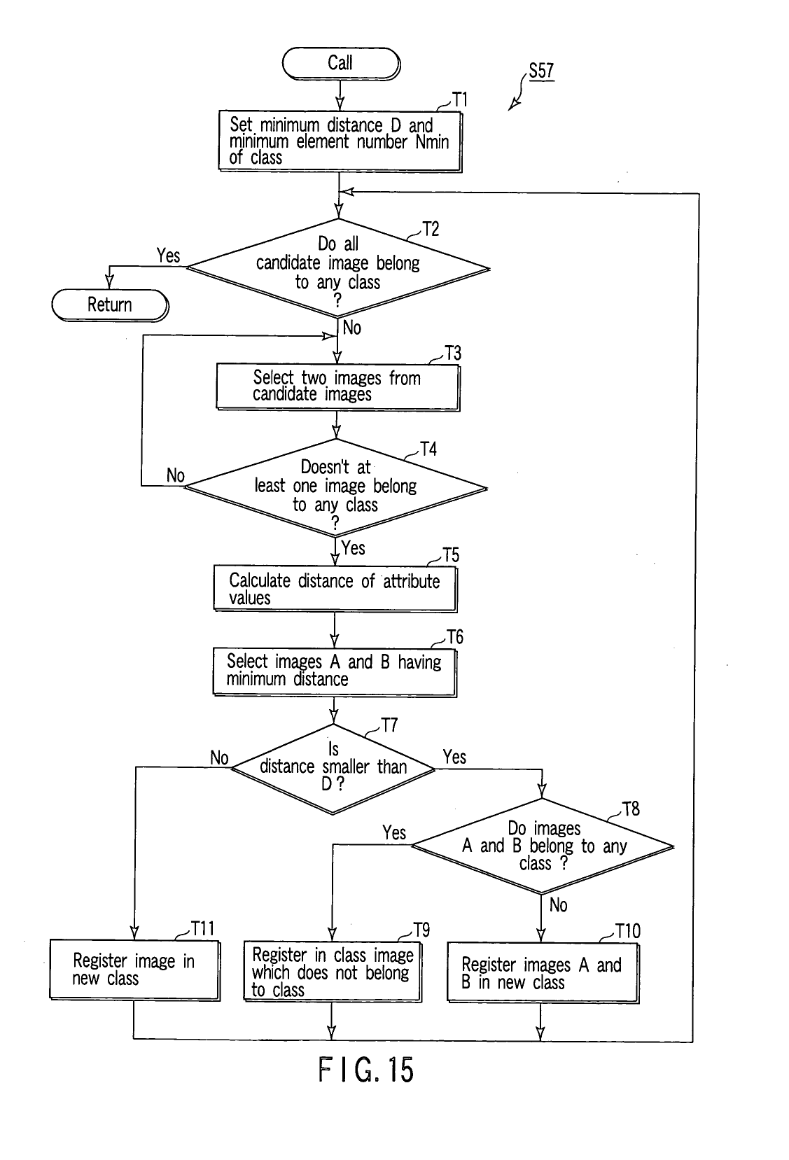

FIG. 15 is a view showing a procedure of the clustering.

In step T1, a minimum distance D and a minimum element number Nₘᵢₙ of the class which are reference values of the clustering processing are set.

In step T2, whether all of the candidate images belong to any of classes Ci. If No in step T2, i.e., if there are candidate images which do not be long to any class Ci, two images are selected from the candidate images in step T3. Then, in step T4, whether there is a combination in which at least one image does not belong to any class Ci is checked.

If Yes in step T4, i.e., if there is a combination in which at least one image does not belong to any class Ci in sets of the two candidate images, a distance X_{AB} between attribute values of the image A and the image B is calculated.

Here, a square of the distance X_{AB} between the attribute values of the image A and the image B is defined by Expression (6).
X_{AB}²=(X_{A}−X_{B})² Expression (6)
X_{A}: attribute value vector of the image A
X_{B}: attribute value vector of the image B

Then, in step T6, a combination of the images A and B that the distance X_{AB} between the attribute values become minimum is selected. That is, the combination of the images A and B selected here has the highest possibility that the both images belong to the same class.

In step T7, the distance X_{AB} between the attribute values is compared with the minimum distance D as the reference value. If Yes in step T7, i.e., if the distance X_{AB} between the attribute values is smaller than the minimum distance D as the reference value, it is judged that the images A and B selected here belong to the same class.

Thus, in step T8, whether one of the images A and B belongs to any class is checked. If Yes in step T8, i.e., if one of the images A and B belongs to a class Ci, the other image should be belong to the same class Ci and it is registered in the class Ci in step T9. Then, step T2 and the subsequent steps are again executed.

If No in step T8, i.e., if both of the images A and B do not belong to the class Ci, the images A and B are registered in a new class Cj in step T10. Then, step T2 and the subsequent steps are again executed.

If No in step T7, i.e., if the distance X_{AB} between the attribute values is larger than the minimum distance D as the reference value, it is judged that the images A and B selected here do not belong to the same class. Thus, in step T11, an image which does not belong to a class in the images A and B is registered in a new class. At this time, if both of the images A and B do not belong to a class, each of the images is registered in another new class. Then, step T2 and the subsequent steps are again executed.

If Yes in step T2, i.e., if all the images as the candidate images belong to any class Ci, the clustering processing is terminated.

After the clustering processing mentioned above, a clustering judgment portion 42 checks whether a localized cluster exists in step S58. That is, if the number of elements (number of images) which belong to a class is larger than the minimum element number Nₘᵢₙ and there is a class that attribute values of all the images belonging to this class fall within a predetermined range, it is judged that this class is a localized class, and such a class is determined as a candidate class.

That is, of the extracted images, if many images having a characteristic attribute value exist, images having an attribute value close to the characteristic attribute value are newly retrieved as similar images.

If Yes in step 58, i.e., if there is a localized class, a parameter retrieving portion 43 checks attribute values of images belonging to a candidate cluster and retrieves original images having attribute values included in a distribution range of their attribute values in step S59. Then, the images to be retrieved are determined as images which are not selected in step S56.

Here, the distribution range of the attribute values means a range of attribute values which can be judged as belonging to this cluster. For example, this means retrieving each original image that a distance from a gravity point of the characteristic vector of an image belonging to this cluster is not more than a predetermined value.

In step S60, the image display portion 13 displays on a display device (not shown), the primary selected images, images extracted by the symbol retrieving mode and images retrieved by utilizing clustering as a retrieval result. It is to be noted that the clustering processing is a method utilizing the statistics, and many other techniques other than this are known. A clustering technique other than one described in conjunction with this embodiment may be utilized.

According to the image retrieving apparatus of the third embodiment, since similar images are retrieved by a combination of the retrieval based on attribute values and the symbol retrieval and the image retrieval based on clustering is also applied, missing of the similar image retrieval can be reduced, and the retrieval accuracy can be further improved.

As described above, according to each of the foregoing embodiments, since the concept of “symbol” is introduced, the labor for the grant operations can be greatly reduced as compared with the conventional keyword grant operation. Furthermore, since the symbol to be given does not have to be a keyword, there is no burden to select a keyword in retrieval. Moreover, since the symbol retrieval is also combined and used in addition to the conventional similar image retrieving method, the similar image retrieval accuracy can be improved.

Additionally, since the weighting coefficient based on the attribute values is adopted, the similar image retrieval accuracy can be improved.

Further, since the image retrieval based on clustering is adopted, missing of the similar image retrieval can be reduced, thereby further increasing the retrieval accuracy.

It is to be noted that the functions described in conjunction with each of the foregoing embodiment can be configured by using hardware, but it can be also realized by causing a computer to read a program in which each function is written by using software. Furthermore, each function may be constituted by appropriately selecting software or hardware.

Moreover, each function can be realized by causing a computer to read a program stored in a non-illustrated storage medium. Here, a storage form of the storage medium in this embodiment may have any conformation as long as this storage medium can store a program and can be read by the computer.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. An image retrieving apparatus comprising:
image inputting means for inputting an image;
attribute value acquiring means for acquiring attribute values obtained by quantifying characteristics of the inputted image;
image saving means for saving the image and the attribute values of the image in association with each other;
first retrieving means for determining an image inputted by the image inputting means or an image selected from a plurality of images saved in the image saving means as a first reference image, and retrieving at least one first image similar to the first reference image from the plurality of images saved in the image saving means based on the attribute values;
retrieved image displaying means for displaying reduced images of the retrieved at least one first image;
image selecting means for allowing an image retrieval requester to select at least one second image similar to the first reference image based on the displayed reduced images;
symbol giving means for newly providing a category which is a data area used to give symbols representing the similarity and the non-similarity with respect to the first reference image to all the images saved in the image saving means, and giving a symbol representing the similarity to the category for each of the selected at least one second image; and
numeric value allocating means for giving a numeric value representing the reliability of the similarity in accordance with the category.

2. The image retrieving apparatus according to claim 1, wherein the first retrieving means determines an image selected from a plurality of images inputted by the image inputting means or a plurality of images saved in the image saving means as a second reference image, and retrieves at least one third image similar to the second reference image from the plurality of images saved in the image saving means based on the attribute values,
the image retrieving apparatus further comprising:
category selecting means for selecting at least one category which is used to retrieve images similar to the second reference image based on the symbol given in accordance with the category of the retrieved at least one third image and the numeric value;
second retrieving means for retrieving images having a symbol representing the similarity given to the selected at least one category from the plurality of images saved in the image saving means.

3. The image retrieving apparatus according to claim 2, further comprising:
clustering means for classifying at least one third image into at least one class based on the attribute values of the image;
clustering judging means for judging a class whose image number belonging thereto is not less than a predetermined number among the classes;
third retrieving means for retrieving at least one image classified as belonging to the judged class from the plurality of images saved in the image saving means.

4. The image retrieving apparatus according to claim 2, wherein the first retrieving means comprises similarity judging means for calculating the similarity of images by comparing the attribute values of the second reference image and the attribute values of the images saved in the image saving means, and judging the similarity of the images.

5. The image retrieving apparatus according to claim 1, wherein the first retrieving means determines as a second reference image an image selected from a plurality of images inputted by the image inputting means or a plurality of images saved in the image saving means, and retrieves at least one third image similar to the second reference image from the plurality of images saved in the image saving means based on the attribute values,
the retrieved image displaying means displays reduced images of the retrieved at least one third image,
and the image selecting means allows an image retrieval requester to select at least one fourth image similar to the second reference image based on the displayed reduced images,
the image retrieving apparatus further comprising:
category selecting means for selecting at least one category which is used to further retrieve an image similar to the second reference image based on the symbol given in accordance with the category of the selected fourth image and the numeric value; and
second retrieving means for retrieving an image having the symbol representing the similarity given to the selected category from the plurality of images saved in the image saving means.

6. The image retrieving apparatus according to claim 5, further comprising:
clustering means for classifying at least one fourth image into at least one class based on the attribute values of the image;
clustering judging means for judging a class that the number of images belonging thereto is not less a predetermined number; and
third retrieving means for retrieving at least one image classified as belonging to the judged class from the plurality of images saved in the image saving means.

7. The image retrieving apparatus according to claim 1, wherein the first retrieving means comprises similarity judging means for calculating the similarity of images by comparing the attribute values of the first reference image and the attribute values of the images saved in the image saving means, and judging the similarity of the images.

8. The image retrieving apparatus according to claim 7, wherein the first retrieving means comprises image sorting means for sequencing the plurality of images saved in the image saving means in the similarity descending order;

9. The image retrieving apparatus according to claim 1, wherein the numeric value allocating means comprises numeric value calculating means for calculating a numeric value representing the reliability of the similarity based on a statistic representing a distribution state of the attribute values of the selected at least one second image.

10. An image retrieving apparatus comprising:
image inputting means for inputting an image;
attribute value acquiring means for acquiring attribute values obtained by quantifying characteristics of an inputted image;
image saving means for saving the image and the attribute values of the image in association with each other;
first retrieving means for determining an image selected from a plurality of images inputted by the image inputting means or a plurality of images saved in the image saving means as a first reference image, and retrieving at least one first image similar to the first reference image from the plurality of images saved in the image saving means based on the attribute values;
retrieved image displaying means for displaying reduced images of the retrieved at least one first image;
image selecting means for allowing an image retrieval requester to select at least one second image similar to the first reference image based on the displayed reduced images; and
numeric value allocating means for newly providing a category which is a data area used to give numeric values representing the similarity and the non-similarity with respect to the first reference image to all the images saved in the image saving means, and giving a numeric value representing the reliability of the similarity to the first reference image in accordance with the category for each of the selected at least one second image.

11. The image retrieving apparatus according to claim 10, wherein the first retrieving means determines an image selected from a plurality of images inputted by the image inputting means or a plurality of images saved in the image saving means as a second reference image, and retrieves at least one third image similar to the second reference image from the plurality of images saved in the image saving means based on the attribute values,
the image retrieving apparatus further comprising:
category selecting means for selecting at least one category which is used to retrieve an image similar to the second reference image based on the numeric values given in accordance with the category of the retrieved at least one third image; and
second retrieving means for retrieving an image having a numeric value representing the reliability of the similarity being not less than a predetermined value in the selected at least one category from the plurality of images saved in the image saving means.

12. The image retrieving apparatus according to claim 10, wherein the first retrieving means determines an image selected from a plurality of images inputted by the image inputting means or a plurality of images saved in the image saving means as a second reference image, and retrieves at least one third image similar to the second reference image from the plurality of images saved in the image saving means based on the attribute values,
the retrieved image displaying means displays reduced images of the retrieved at least one third image, and
the image selecting means allows an image retrieval requester to select at least one fourth image similar to the second reference image based on the displayed reduced images,
the image retrieving apparatus further comprising:
category selecting means for selecting at least one category which is used to further retrieve an image similar to the second reference image based on the numeric value given in accordance with the category of the selected fourth image; and
second retrieving means for retrieving an image having a numeric value representing the reliability of the similarity being not less than a predetermined value in the selected category based on the similarities of the plurality of images saved in the image saving means.

13. An image retrieving program causing a computer to execute:
an image input step of inputting an image;
an attribute value acquisition step of acquiring attribute values obtained by quantifying characteristics of the inputted image;
an image saving step of saving the image and the attribute values of the image in association with each other;
a retrieval step of determining an image selected from a plurality of images inputted in the image input step and a plurality of images saved in the image saving step as a first reference image, and retrieving at least one first image similar to the first reference image from the plurality of images saved in the image saving step based on the attribute values;
a retrieved image display step of displaying reduced images of the retrieved at least one first image;
an image selection step of allowing an image retrieval requester to select at least one second image similar to the first reference image based on the displayed reduced images;
a symbol giving step of newly providing a category which is a data area used to give symbols representing the similarity and the non-similarity with respect to the first reference image to each of all the images saved in the image saving step, and giving a symbol representing the similarity to the category in accordance with the selected at least one second image; and
a numeric value allocation step of giving a numeric value representing the reliability in accordance with the category.

14. The image retrieving program according to claim 13, wherein the image retrieving program causes the computer to further execute a retrieval step of determining an image selected from a plurality of images inputted in the image input step or a plurality of images saved in the image saving step as a second reference image, and retrieving at least one third image similar to the second reference image from the plurality of images saved in the image saving step based on the attribute values;
a category selection step of selecting at least one category used to retrieve an image similar to the second reference image based on the symbols given to each category of the retrieved at least one third image and the numeric value; and
a retrieval step of retrieving an image having a symbol representing the similarity given to the selected at least one category from the plurality of images saved in the image saving step.

15. The image retrieving program according to claim 14, wherein the image retrieving program causes the computer to further execute:
a clustering step of classifying the at least one third image into at least one class based on the attribute values of the image;
a clustering judgment step of judging a class that the number of images belonging thereto is not less than a predetermined number in the classes; and
a retrieval step of retrieving at least one image which is classified as belonging to the judged class from the plurality of images saved in the image saving step.

16. The image retrieving program according to claim 13, wherein the image retrieving program causes the computer to further execute:
a first retrieval step of determining an image selected from the plurality of images inputted in the image input step or the plurality of images saved in the image saving step as a second reference image, and retrieving at least one third image similar to the second reference image from the plurality of images saved in the image saving step based on the attribute values;
a step of displaying reduced images of the retrieved at least one third image;
a step of allowing an image retrieval requester to select at least one fourth image similar to the second reference image based on the displayed reduced images;
a category selection step of selecting at least one category used to further retrieve an image similar to the second reference image based on the symbols given to each category of the selected fourth image and the numeric value; and
a second retrieval step of retrieving an image having a symbol representing the similarity given to the selected category from the plurality of images saved in the image saving step.

17. The image retrieving program according to claim 16, wherein the image retrieving program causes the computer to further execute:
a clustering step of classifying the at least one fourth image into at least one class based on the attribute values of the image;
a clustering judgment step of judging a class that the number of images belonging thereto is not less than a predetermined number in the classes; and
a retrieval step of retrieving at least one image classified as belonging to the judged class from the plurality of images saved in the image saving step.

18. An image retrieving program which causes a computer to execute:
an image input step of inputting an image;
an attribute value acquisition step of acquiring attribute values obtained by quantifying characteristics of the inputted image;
an image saving step of saving the image and the attribute values of the image in association with each other;
a retrieval step of determining an image selected from a plurality of images inputted in the image input step or a plurality of images saved in the image saving step as the first reference image, and retrieving at least one first image similar to the first reference image from the plurality of images saved in the image saving step based on the attribute values;
a retrieved image display step of displaying reduced images of the retrieved at least one first image;
an image selection step of allowing an image retrieval requester to select at least one second image similar to the first reference image based on the displayed reduced images; and
a numeric value allocating step of newly providing a category which is a data area used to give a numeric value representing the similarity or the non-similarity with respect to the first reference image to each of all the images saved in the image saving step, and giving a numeric value representing the reliability of the similarity with respect to the first reference image in accordance with the category for each of the selected at least one second image.

19. The image retrieving program according to claim 18, wherein the image retrieving program causes the computer to further execute:
a first retrieval step of determining an image selected from the plurality of images inputted in the image input step or the plurality of images saved in the image saving step as a second reference image, and retrieving at least one third image similar to the second reference image from the plurality of images saved in the image saving step based on the attribute values;
a category selection step of selecting at least one category which is used to retrieve an image similar to the second reference image based on the numeric value given to each category of the retrieved at least one third image; and
a second retrieval step of retrieving an image whose numeric value representing the reliability of the similarity of the selected at least one category is not less than a predetermined value from the plurality of images saved in the image saving step.

20. The image retrieving program according to claim 18, wherein the image retrieving program causes the computer to further execute:
a retrieval step of determining an image selected from the plurality of images inputted in the image input step or the plurality of images saved in the image saving step as a second reference image, and retrieving at least one third image similar to the second reference image from the plurality of images saved in the image saving step based on the attribute values;
a step of displaying reduced images of the retrieved at least one third image;
a step of allowing an image retrieval requester to select at least one fourth image similar to the second reference image based on the displayed reduced images;
a category selection step of selecting at least one category which is used to further retrieve an image similar to the second reference image based on the numeric value given to each category of the selected fourth image; and
a retrieval step of retrieving an image whose numeric value representing the reliability of the similarity of the selected category is not less than a predetermined value based on the reliabilities of the plurality of images saved in the image saving step.
